(19) United States
(12) Patent Application Publication
(10) Pub. No.: US 2014/0182277 A1
(43) Pub. Date: Jul. 3, 2014

(54) Electro-Hydraulic Steering System with Spool-Based Steering Event Detection

(71) Applicant: CATERPILLAR INC., Peoria, IL (US)

(72) Inventors: Beau Kuipers, Morris, IL (US); Wendell D. Stahl, Bradford, IL (US); Edward W. Mate, Manhattan, IL (US); Joshua M. Adams, Sahuarita, AZ (US); Shawn I. Cullen, Metamora, IL (US)

(73) Assignee: CATERPILLAR INC., Peoria, IL (US)

(21) Appl. No.: 13/727,831

(22) Filed: Dec. 27, 2012

(51) Int. Cl. B62D 5/09

(52) U.S. Cl. CPC B62D 5/09
USPC 60/327; 60/444

(57) ABSTRACT

An electro-hydraulic steering system for an articulated machine includes an electrical circuit and a hydraulic circuit. The electrical circuit includes a controller, an electro-hydraulic valve assembly, and a spool position system. The hydraulic circuit includes a pump, at least one cylinder in selective fluid communication with the pump, and the valve assembly. The controller includes a computer-readable storage medium storing a steering system monitoring application which performs several steps. A desired flow of pressurized fluid to each cylinder and a desired spool position for the spool of the electro-hydraulic valve assembly, based upon the desired flow of pressurized fluid, are determined. The desired spool position and an actual spool position are compared to determine a spool-based flow error, which is summed over a period of time to determine a cumulative spool-based flow error. An event warning is issued when the cumulative spool-based flow error exceeds a threshold.

### TECHNICAL FIELD

This patent disclosure relates, generally, to an electro-hydraulic steering system, and, more particularly, to a monitoring system for an electro-hydraulic steering system of a machine, such as a motor grader or a wheel loader, for example.

### BACKGROUND

Machines, such as, wheel loaders, haul trucks, motor graders, and other types of heavy equipment, include a front frame member, a rear frame member, and an articulation joint connecting the front and rear frame members. In another example, the machine can include one or more wheels that pivot about a vertical joint between the wheel and a frame. Such a steering linkage known as an “Ackerman steering linkage” can be used to pivot a pair of wheels mounted on an axle on separate pivot pins.

Typically, to steer an articulated machine, the front frame member must be rotated relative to the longitudinal axis of the rear frame member about the articulation joint. To rotate the front frame member, these machines commonly include articulation cylinders mounted between the front and rear frame members. The articulation cylinders are operated in opposing directions so that one cylinder is extended while the other cylinder is retracted (and vice versa), thereby causing the front of the machine to face the intended turn on the side of the retracting cylinder.

The steering of a machine may be controlled through a number of different approaches. In many cases with mobile construction equipment, one or more steering cylinders are hydraulically controlled. One technique includes controlling the actual steering position of the machine based on a desired positional input of an operator. In other words, as the operator turns a steering wheel or tilts a joystick lever to a particular position or angle away from a neutral position, the articulated joint or wheel is pivoted an amount corresponding to the particular angle.

In response to an operator input to a steering system, the appropriate hydraulic cylinders extend and retract to cause the front frame to pivot about the articulated joint relative to the rear frame, thereby steering the machine. A hydraulic cylinder may be connected between the wheel and the frame of the machine to extend and retract in response to an operator input to a steering system, thereby causing the wheel to pivot about the joint and steer the machine.

An electro-hydraulic steering system for such machines can include an event warning system which is adapted to detect abnormal events in the electro-hydraulic steering and, if such an event is detected, issue a warning notification to the machine operator. The warning notification informs the operator that the machine has suffered a failure that requires immediate attention. When such events are detected, the vehicle is stopped at the earliest possible opportunity and checked for such conditions. Conventional systems detect such events based on the sensed piston position of hydraulic cylinders of the electro-hydraulic steering. Many of these warnings are falsely triggered which can result in extensive trouble shooting and unnecessary component changes.

U.S. Pat. No. 8,042,568 is entitled, “Fluid Controller and a Method of Detecting an Error in a Fluid Controller.” The '568 patent is directed to a fluid controller for controlling a machine, e.g. for steering a vehicle. The controller comprises a housing defining an inlet port connected to the source and an outlet port connected to the pressure operated device. The flow rate is controlled by movement of a valve member within the housing, and a processor provides a reference which is indicative of a desired position of the valve member relative to the housing. The fluid controller comprises a fault detection system based on an observer. The observer calculates a theoretically correct position of the valve member relative to the housing for a given reference, and compares this position to an obtained position of the valve member relative to the housing. The difference between the positions is compared with a threshold value. In order to dynamically change the sensitivity of the system, the threshold value is scaled based on a gradient of the reference.

It will be appreciated that this background description has been created by the inventors to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure is directed to, in one embodiment, an electro-hydraulic steering system for a machine. The electro-hydraulic steering system includes a controller, an electro-hydraulic valve assembly, a spool position system, a pump, and a first cylinder.

The electro-hydraulic valve assembly is in electrical communication with the controller. The electro-hydraulic valve assembly includes a spool reciprocally movable over a range of travel between at least two flow positions. The electro-hydraulic valve assembly is adapted such that the spool moves in response to a control signal received from the controller.

The spool position system has a sensor adapted to detect the position of the spool of the electro-hydraulic valve assembly and to generate a spool position signal indicative of the position of the spool. The spool position system is in electrical communication with the controller and adapted to send the spool position signal to the controller.

The pump is adapted to provide a source of pressurized fluid. The first cylinder is in selective fluid communication with the pump. The electro-hydraulic valve assembly is adapted to selectively direct the source of pressurized fluid to the first cylinder in response to the control signal received from the controller.

The controller is adapted to perform steering system monitoring. The controller determines a desired flow of pressurized fluid to the first cylinder based upon a particular steering signal received by the controller. The controller determines a desired spool position for the spool of the electro-hydraulic valve assembly based upon the desired flow of pressurized fluid. An actual spool position is determined based upon the spool position signal received from the spool position system. The desired spool position and the actual spool position are compared to determine a spool-based flow error. The spool-based flow error over a predetermined period of time is summed or integrated to calculate a cumulative spool-based flow error for the predetermined period of time. An event warning is issued when the cumulative spool-based flow error for the predetermined period of time is outside of a predetermined range.

In another embodiment, a controller for an electro-hydraulic steering system of a machine includes a processor and a non-transitory, tangible computer-readable storage medium bearing instructions comprising a steering system monitoring application. When executed by the processor, the steering system monitoring application performs several steps.

A desired flow of pressurized fluid to a first cylinder for a particular steering condition is determined. A desired spool position is determined, based upon the desired flow of pressurized fluid, for a spool of an electro-hydraulic valve assembly associated with the first cylinder. An actual spool position is determined based upon a spool position signal received from a spool position system. The desired spool position and the actual spool position are compared to determine a spool-based flow error. The spool-based flow error over a predetermined period of time is summed to calculate a cumulative spool-based flow error for the predetermined period of time. An event warning is issued when the cumulative spool-based flow error for the predetermined period of time is outside of a predetermined range.

In another embodiment, a method of monitoring an electro-hydraulic steering system of a machine is described. A desired flow of pressurized fluid to a first cylinder is determined based upon a particular steering signal received by a controller. A desired spool position is determined, based upon the desired flow of pressurized fluid, for a spool of an electro-hydraulic valve assembly associated with the first cylinder. The electro-hydraulic valve assembly is adapted to selectively direct a source of pressurized fluid to the first cylinder. An actual spool position is determined using a spool position system. The desired spool position and the actual spool position are compared to determine a spool-based flow error. The spool-based flow error over a predetermined period of time is summed to calculate a cumulative spool-based flow error for the predetermined period of time. An event warning is issued when the cumulative spool-based flow error for the predetermined period of time is outside of a predetermined range.

Further and alternative aspects and features of the disclosed principles will be appreciated from the following detailed description and the accompanying drawings. As will be appreciated, the electro-hydraulic steering systems, controllers, and methods of monitoring an electro-hydraulic steering system of a machine disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a side elevational view of an embodiment of a machine having an embodiment of an electro-hydraulic steering system constructed in accordance with principles of the present disclosure.

FIG. 2 is a top plan view of the machine of FIG. 1.

FIG. 3 is a schematic top plan view of the machine of FIG. 1, illustrating a front frame of the machine rotated to a full right articulation angle θ.

FIG. 4 is a schematic and diagrammatic view of an exemplary embodiment of an electro-hydraulic steering system for the machine of FIG. 1.

FIG. 5 is a schematic and diagrammatic view of an exemplary embodiment of an electro-hydraulic monitoring system of the electro-hydraulic steering system for the machine of FIG. 1.

FIG. 6 is a flow chart illustrating steps of an embodiment of a method of monitoring an electro-hydraulic steering system of a machine according to principles of the present disclosure.

### DETAILED DESCRIPTION

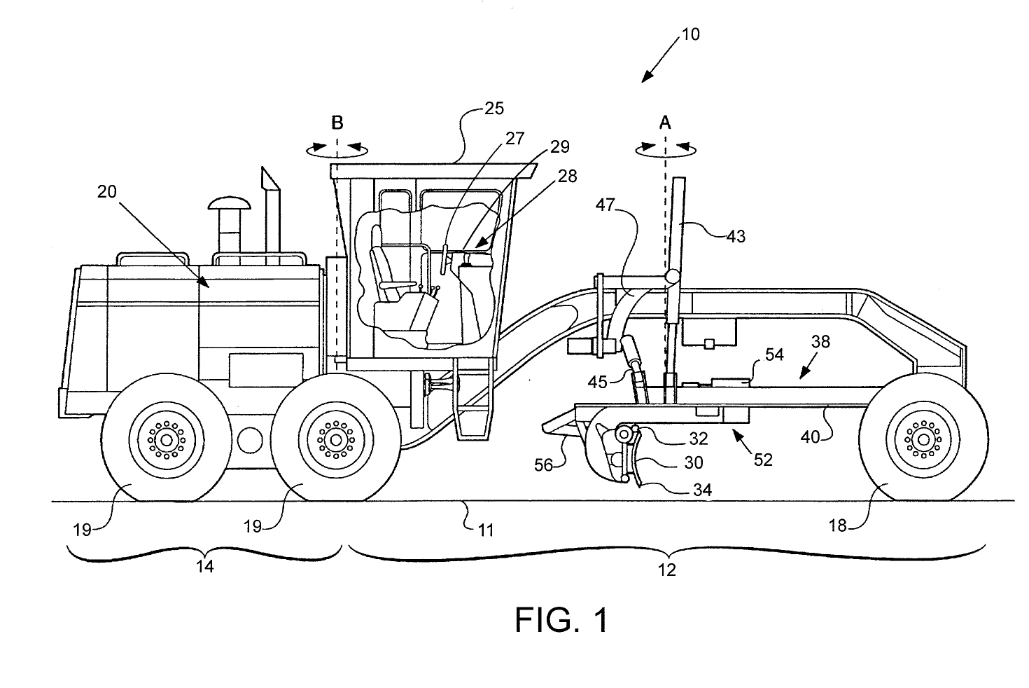

Referring now to the drawings, an exemplary embodiment of a machine in the form of a motor grader 10 having an exemplary embodiment of a steering system constructed in accordance with principles of the present disclosure is shown in FIGS. 1-3. The motor grader 10 can be used as a finishing tool to sculpt a work surface 11 to a final arrangement.

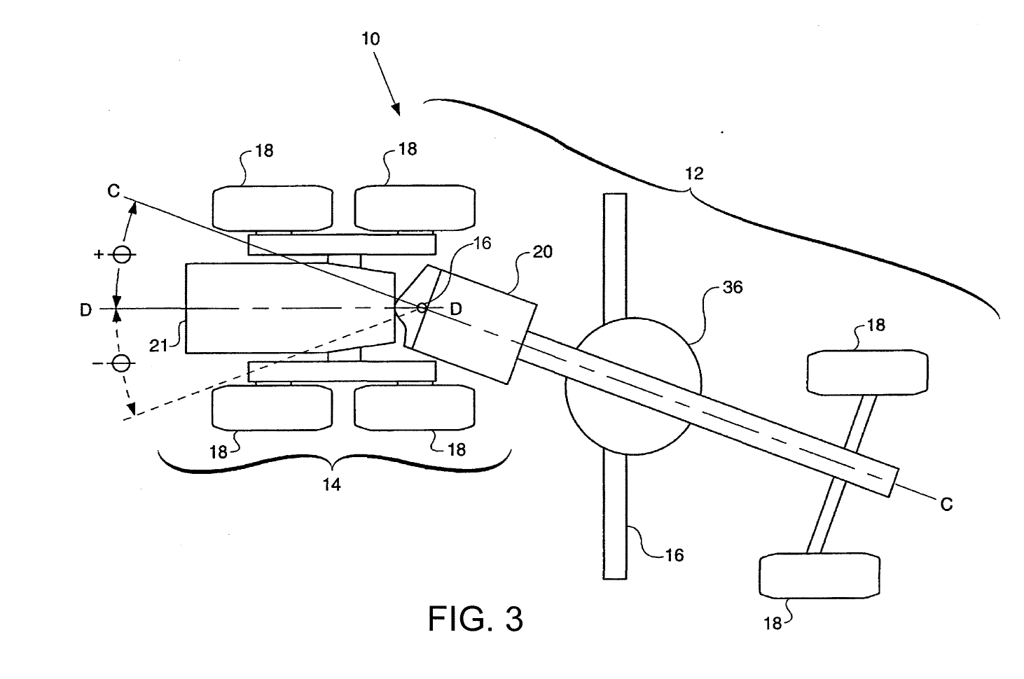

The motor grader 10 includes a front frame 12 and a rear frame 14, which are pivotably connected to each other via an articulation joint 16 (see FIG. 3). The front frame 12 and the rear frame 14 are respectively supported by front tires 18 and rear tires 19. In other embodiments, the machine can include other ground-engaging devices for propelling the machine, such as track assemblies, for example, as known in the art.

An engine, transmission, and differential axle collectively comprise a drive system 20 supported by the rear frame 14. The drive system 20 is adapted to drive or power the motor grader 10. In embodiments, the transmission includes a plurality of forward and reverse gears and a neutral gear in which none of the forward and reverse gears are engaged. In embodiments, a motor grader transmission includes up to eight forward gears and eight reverse gears. The transmission is connected to a differential axle having a rear tire 19 on each side that may be locked so that both rear tires 19 may be driven during slippery conditions. In embodiments, the motor grader 10 can include an all-wheel drive system.

An operator cab 25 is mounted to the front frame 12. The operator cab 25 can contain many controls of the motor grader 10, including operator input devices, such as a steering wheel 27 or a joystick 28, used to steer the motor grader 10. The operator cab 25 can also include a display device 29 adapted to convey to the operator information concerning the operation of the machine, including an event warning indicating a steering system fault condition. The display device 29 can comprise any suitable device known to those skilled in the art which is adapted to provide graphical and/or audibly perceptible information concerning the operational conditions of the machine.

A blade 30, sometimes referred to as a moldboard, is provided that includes a top 32 and a cutting edge 34. The blade 30 can be used to move earth. The blade 30 is supported by the front frame 12 and is mounted on a linkage assembly 38. The linkage assembly 38 allows the blade 30 to be moved over a variety of different positions with respect to the motor grader 10.

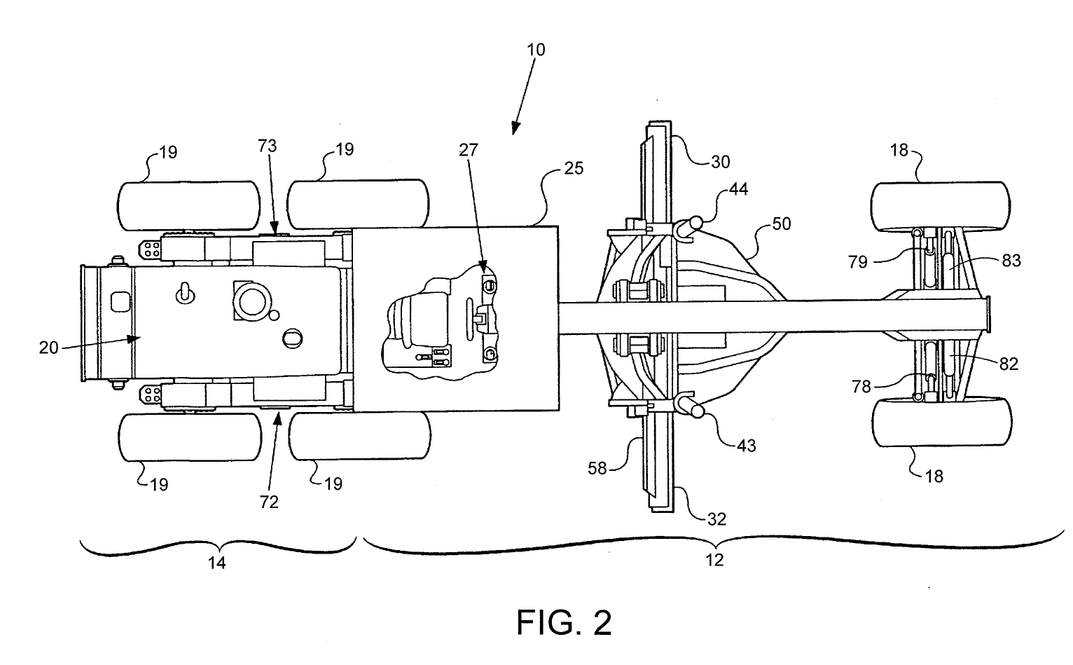

The linkage assembly 38 includes a drawbar 40 mounted to the front frame 12 by a ball joint. The position of the drawbar 40 is controlled by a right lift cylinder 43, a left lift cylinder 44 (see FIG. 2), and a center shift cylinder 45. A coupling 47 connects the right lift cylinder 43, the left lift cylinder 44, and the center shift cylinder 45 to the front frame 12. The coupling 47 can be moved when the blade 30 is repositioned, and can be held in place during earthmoving operations. The height of the blade 30 with respect to the work surface 11 below the motor grader 10—commonly referred to as the blade height—can be controlled with the right lift cylinder 43 and the left lift cylinder 44. The right lift cylinder 43 and the left lift cylinder 44 are adapted to raise and lower the associated end of the blade 30. The center shift cylinder 45 is adapted to move the drawbar 40 from side to side relative to the front frame 12.

The drawbar 40 includes a large, flat plate commonly referred to as a yoke plate 50 (see FIG. 2). Beneath the yoke plate 50 is a large gear, commonly referred to as a circle 52. The circle 52 is rotated by a hydraulic motor commonly referred to as a circle drive 54, as shown in FIG. 1. Rotation of the circle 52 by the circle drive 54 pivots the blade 30 about a blade axis “A” relative to the drawbar 40 to establish a blade cutting angle. The blade cutting angle is defined as the angle of the blade 30 relative to a longitudinal axis “C” of the front frame 12 (see FIG. 3). At a zero degree blade cutting angle, the blade 30 extends in perpendicular relation to the front frame 12. In FIG. 2, the blade 30 is set at a zero degree blade cutting angle.

The blade 30 can be mounted to a hinge (not shown) on the circle 52 with a bracket (not shown). A blade tip cylinder 56 is adapted to pitch the bracket forward or rearward and thus tilt the top 32 of the blade 30 forward and rearward relative to the cutting edge 34, thereby adjustably controlling the angle between the bottom cutting edge 34 of the blade 30 and the work surface 11. The blade 30 can be mounted to a sliding joint in the bracket which allows the blade 30 to move from side to side with respect to the bracket. A side shift cylinder 58 (see FIG. 2) is adapted to control the relative side- to-side movement of the blade 30.

Referring to FIG. 2, a right articulation cylinder 72 is mounted to the right side of the rear frame 14 and a left articulation cylinder 73 is mounted to the left side of the rear frame 14. The right and left articulation cylinders 72, 73 are adapted to be hydraulically operated to rotate the front frame 12 about an articulation axis “B,” shown in FIG. 1, relative to the rear frame 14. In FIG. 2, the motor grader 10 is positioned in a neutral or zero articulation angle. The rear tires 19 are driven by the differential (not shown) of the drive system 20, as is well known in the art.

Adjacent the front tires 18 are a right steering cylinder 78 and a left steering cylinder 79. The right steering cylinder 78 and the left steering cylinder 79 are adapted to be hydraulically operated to control the position of the front tires 18 and thus can be controlled to help steer the motor grader 10. A right wheel lean cylinder 82 and a left wheel lean cylinder 83 are also provided and adapted to be hydraulically operated to tilt the respective front tires 18 with which they are associated on the front frame 12 from left to right.

Referring to FIG. 3, the motor grader 10 is shown with the front frame 12 rotated with respect to the rear frame 14 to a full right articulation angle θ. The articulation angle θ is formed by the intersection of a longitudinal axis “C” of the front frame 12 and a longitudinal axis “D” of the rear frame 14. The articulation joint 16 connects the front frame 12 and the rear frame 14. A rotary sensor, used to measure the articulation angle θ, can be positioned at the articulation joint 16. A full left articulation angle θ, shown in phantom lines in FIG. 3, is a mirror image of the full right articulation angle θ. The right and left articulation cylinders 72, 73 are adapted to be hydraulically operated to rotate the front frame 12 with respect to the rear frame 14 about the articulation axis “B” over a range of travel between the full right articulation angle θ and the full left articulation angle θ such that the front frame 12 can be disposed in any articulation angle θ therebetween.

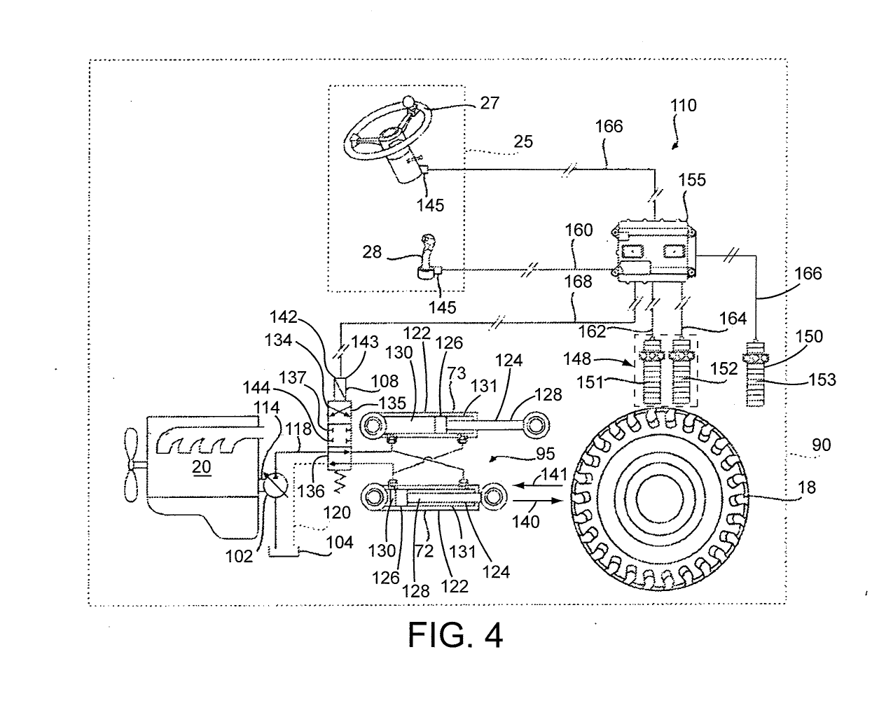

Referring to FIG. 4, an electro-hydraulic steering system 90 for the motor grader 10 is adapted to control the articulation angle θ of the motor grader 10. The electro-hydraulic steering system 90 is adapted to selectively, alternately reciprocate the hydraulic right and left articulation cylinders 72, 73, thereby steering the motor grader 10.

The electro-hydraulic steering system 90 includes a hydraulic circuit 95 and an electrical circuit 110. The hydraulic circuit 95 includes a pump 102, a tank 104 in fluid communication with the pump, an electro-hydraulic valve assembly 108 in selective fluid communication with both the pump 102 and the tank 104, and the right and left articulation cylinders 72, 73 each in selective fluid communication with the pump 102 and the tank 104. The electrical circuit 110 can include the electro-hydraulic valve assembly 108, steering input sensors 145, an articulation cylinder position system 148, and a spool position system 150, each of which in electrical communication with a controller 155.

The pump 102 is adapted to provide a source of pressurized fluid. In embodiments, the pump 102 can be adapted to produce a flow of pressurized fluid and can comprise a variable displacement pump, a fixed displacement pump, a variable flow pump, or any other device for producing a source of pressurized fluid known in the art. The pump 102 can be drivably connected to the drive system 20 by, e.g., a countershaft 114, a belt (not shown), an electric circuit (not shown), or any other suitable device or technique. Although FIG. 4 illustrates the pump 102 as being dedicated to supplying pressurized fluid to only the hydraulic circuit 95, it is contemplated that, in embodiments, the pump 102 can supply pressurized fluid to additional machine hydraulic circuits.

The illustrated pump 102 of pressurized fluid is in the form of a variable displacement pump. The pump 102 can be adapted to provide both high hydraulic pressure and a relatively lower pilot pressure. The pump 102 receives a rotary motion to produce high hydraulic pressure. In the illustrated embodiment, the drive system 20 in the form of an engine imparts the rotary motion. Low pilot pressure can be provided from the pump 102 via a hydraulic pressure reducing valve (not shown). The hydraulic pressure reducing valve can receive high hydraulic pressure from the pump 102 and supply low pilot pressure to the electro-hydraulic valve assembly 108. The pressure-reducing valve can be any suitable device as are well-known in the art. A supply line 118 can be provided between the pump 102 and the electro-hydraulic valve assembly 108 to allow hydraulic fluid to selectively flow from the pump 102 through the electro-hydraulic valve assembly 108 to the right and left articulation cylinders 72, 73.

The tank 104 can comprise a reservoir configured to hold a supply of hydraulic fluid. The fluid may include, for example, an engine lubrication oil, a transmission lubrication oil, a separate hydraulic oil, or any other suitable fluid known in the art. The pump 102 can be adapted to draw fluid from and return fluid to the tank 104. In other embodiments, the pump 102 can be fluidly connected to multiple separate tanks A drain line 120 can be provided between the tank 104 and the electro-hydraulic valve assembly 108 to allow hydraulic fluid to return to the tank 104 from the right and left articulation cylinders 72, 73.

The right articulation cylinder 72 and the left articulation cylinder 73 each includes a body 122 and a reciprocally movable piston assembly 124 disposed within the body 122. The piston assembly 124 including a piston 126 and a rod 128 extending from the body 122. The piston assembly 124 is reciprocally movable over a range of travel between a retracted position and an extended position. The body 122 defines a piston-side chamber 130 and a rod-side chamber 131. The right and left articulation cylinders 72, 73 can be any suitable hydraulic cylinder as will be appreciated by one skilled in the art. The right articulation cylinder 72 and the left articulation cylinder are both associated with the articulation cylinder position system 148 which is adapted to provide signals to the controller 155 indicative of the actual location of the right and left articulation cylinders 72, 73 for comparison to respective desired locations.

The right and left articulation cylinders 72, 73 are adapted to receive controlled high hydraulic pressure from the pump 102 and produce a mechanical movement by alternately retracting and extending the piston assembly 124 to rotate the front frame 12 of the motor grader 10 with respect to the rear frame 14. As described above, rotation of the front frame 12 of the motor grader 10 with respect to the rear frame 14 thereof establishes the articulation angle θ.

The electro-hydraulic valve assembly 108 is a part of both the hydraulic circuit 95 and the electrical circuit 110. The electro-hydraulic valve assembly 108 is disposed between the pump 102 and the right and left articulation cylinders 72, 73 and between the tank 104 and the right and left articulation cylinders 72, 73 in the hydraulic circuit 95 and is adapted to selectively control the flow of the pressurized fluid to and from the right and left articulation cylinders 72, 73. The electro-hydraulic valve assembly is also in electrical communication with the controller 155. The electro-hydraulic valve assembly 108 is adapted to selectively direct the source of pressurized fluid from the pump 102 to the right articulation cylinder 72 and the left articulation cylinder 73 in response to a control signal received from the controller 155.

The electro-hydraulic valve assembly 108 is in fluid communication with the pump 102 and the tank 104 to control actuation of the hydraulic right and left articulation cylinders 72, 73. The electro-hydraulic valve assembly 108 can include at least one valve element or spool 134 that is configured to selectively and simultaneously meter pressurized fluid to one of the piston-side chamber 130 and the rod-side chamber 131 within the hydraulic right articulation cylinder 72 and the other of the piston-side chamber 130 and the rod-side chamber 131 of the hydraulic left articulation cylinder 73 while the opposite chambers 130, 131 of the right and left articulation cylinders 72, 73 are fluidly connected to the tank 104 to allow hydraulic fluid to drain from these chambers 130, 131 to the tank 104. The electro-hydraulic valve assembly 108 is adapted such that the spool 134 moves in response to a control signal received from the controller 155.

The spool 134 of the electro-hydraulic valve assembly 108 is reciprocally movable over a range of travel between at least two flow positions. The illustrated spool 134 of the electro-hydraulic valve assembly is movable over a range of travel between a first flow position 135, a second flow position 136, and a third flow position 137.

In the first flow position 135, a source of pressurized fluid is allowed to flow from the pump 102 into one of the piston-side chamber 130 and the rod-side chamber 131 of the right articulation cylinder 72 and the other chamber 130, 131 of the left articulation cylinder 73 while allowing the fluid to drain from the opposing chambers 130, 131 of the right and left articulation cylinders 72, 73 to the tank 104. In the second flow position 136, the flow directions are reversed relative to the first flow position 135. In the third flow or neutral position 137, fluid flow is blocked from both of the chambers 130, 131 of the right and left articulation cylinders 72, 73. In other words, pressurized fluid is substantially prevented from flowing from the pump 102 to either the right articulation cylinder 72 or the left articulation cylinder 73 and fluid is substantially prevent from flowing from either of the right and left articulation cylinders 72, 73 to the tank 104. The location of the spool 134 of the electro-hydraulic valve assembly 108 between the first, second, and third flow positions 135, 136, 137 can determine a flow rate of the pressurized fluid into and out of the associated piston-side chamber 130 and rod-side chamber 131 of the right and left articulation cylinders 72, 73 and a corresponding steering velocity (i.e., the time derivative of a steering angle) of the motor grader 10.

In one example, the valve element or spool 134 of the electro-hydraulic valve assembly 108 can be pilot actuated against a spring bias to move between the first flow position 135, the second flow position 136, and the third flow or neutral position 137. In embodiments, the spool 134 can be biased to the third flow or neutral position 137.

In the illustrated first flow position 135, pressurized fluid is allowed to flow from the pump 102 into both the piston-side chamber 130 of the right articulation cylinder 72 and the rod-side chamber 131 of the left articulation cylinder 73 and to flow out of both the rod-side chamber 131 of the right articulation cylinder 72 and the piston-side chamber 130 of the left articulation cylinder 73 to drain fluid to the tank 104. Accordingly, when the electro-hydraulic valve assembly 108 is in the first flow position 135, the right articulation cylinder 72 moves in an extending direction 140 and the left articulation cylinder 73 moves in an opposing retracting direction 141 to thereby pivot the front frame 12 with respect to the rear frame 14 about the articulation axis “B” to the left such that the articulation angle θ moves in a negative direction (see FIG. 3).

In the illustrated second flow position 136, pressurized fluid is allowed to flow from the pump 102 into both the rod-side chamber 131 of the right articulation cylinder 72 and the piston-side chamber 130 of the left articulation cylinder 73 and out of both the piston-side chamber 130 of the right articulation cylinder 72 and the rod-side chamber 131 of the left articulation cylinder 73 to drain fluid to the tank 104. Accordingly, when the electro-hydraulic valve assembly 108 is in the second flow position 136, the right articulation cylinder 72 moves in the retracting direction 141 and the left articulation cylinder 73 moves in the extending direction 140 to thereby pivot the front frame 12 with respect to the rear frame 14 about the articulation axis “B” to the right such that the articulation angle θ moves in a positive direction (see FIG. 3).

In embodiments, the electro-hydraulic valve assembly 108 can comprise a steering control valve 142 includes an electrical solenoid 143 and a valve body 144 housing the spool 134. In embodiments, the steering control valve 142 comprises a proportional valve that is infinitely adjustable over its range of travel. The solenoid 143 receives a control signal from the controller 155 and produces a controlled mechanical movement of the spool 134 to selectively operate the steering control valve 142.

In embodiments, the hydraulic circuit 95 can include additional components and/or different components than those illustrated in FIG. 4, such as, e.g., accumulators, check valves, pressure relief or makeup valves, pressure-compensating elements, restrictive orifices, and other hydraulic components known in the art.

The electrical circuit 110 can include components distributed throughout the machine 10. In particular, the steering input sensors 145 of the electrical circuit 110 are associated with the operator interfaces—in the form of the steering wheel 27 or the joystick 28—in the operator cab 25. The articulation cylinder position system 148 and the spool position system 150 are respectively associated with the right and left articulation cylinders 72, 73 and with the spool 134 of the electro-hydraulic valve assembly 108. The controller 155 is in electrical communication with the steering input sensors 145, the articulation cylinder position system 148 and the spool position system 150. In embodiments, the electrical circuit 110 can include additional components and/or different components than those illustrated in FIG. 4. For example, in embodiments, a travel speed sensor can be provided in the form of a magnetic pickup-type sensor, for example, that is associated with the front and/or rear tires 18, 19 or another drive train component of the motor grader 10 to sense a rotational speed thereof and produce a corresponding speed signal that is directed to the controller 155 and/or other logic component of the machine 10. In embodiments, the electrical circuit 110 can include a steering feedback angle sensor adapted to produce a signal indicative of the orientation of the front frame 12 relative to a travel direction of the machine 10.

Each steering input sensor 145 is adapted to transform the mechanical movements of the operator input devices into corresponding electrical input signals. Each steering input sensor 145 can be adapted to monitor the operation of the associated operator interface device 27, 28 and to generate a steering signal indicative of the operation, which is sent to the controller 155. The steering signal carries steering information to the controller 155. For example, in embodiments, the steering input sensor 145 is in the form of a position sensor adapted to monitor a displacement angle of the operator interface device 27, 28 and generate a corresponding displacement signal correlated to an intended articulation angle θ. The controller 155 can differentiate the monitored displacement angle with respect to time to calculate an angular velocity ω.

In other embodiments, the steering input sensor 145 can include a velocity sensor adapted to directly monitor angular velocity ω and generate a corresponding velocity signal. The angular velocity ω can be integrated to determine an incremental position of the operator interface device 27, 28 which can be used to calculate a displacement angle to generate a displacement signal correlated to an intended articulation angle θ. In embodiments, the electrical circuit 110 can include both a position sensor and a velocity sensor associated with each operator interface device 27, 28.

The articulation cylinder position system 148 can be adapted to detect the actual position of the right articulation cylinder 72 and the left articulation cylinder 73 and to generate a corresponding first cylinder position signal and second cylinder position signal indicative of the position of the right articulation cylinder 72 and the left articulation cylinder 73, respectively. The articulation cylinder position system 148 is in electrical communication with the controller 155 and is adapted to send the first articulation cylinder position signal and the second articulation signal to the controller 155.

The illustrated articulation cylinder position system 148 includes a first cylinder position sensor 151 and a second cylinder position sensor 152, which are respectively associated with the right and left articulation cylinders 72, 73. Each of the first and second cylinder position sensors 151, 152 can be arranged with the respective right and left articulation cylinders 72, 73 such that the first and second cylinder position sensors 151, 152 is adapted to detect the position of the associated piston assembly 124 as it moves over a range of travel between a fully retracted position and a fully extended position.

In other embodiments, the actual steering condition of the system can be detected using other techniques. For example, in other embodiments, the actual steering angle of portions of a machine, such as, e.g., on the articulation joint 16 or on an Ackerman joint in an Ackerman steering linkage, can be detected using a rotary position sensor.

The spool position system 150 can be adapted to detect the position of the spool 134 of the electro-hydraulic valve assembly 108 and to generate a spool position signal indicative of the position of the spool 134. The spool position system 150 can comprise a spool position sensor 153 which is in electrical communication with the controller 155 and is adapted to send the spool position signal to the controller 155. The spool position sensor 153 can be adapted to detect the position of the spool 134 as it moves over a range of travel including the first, second, and third flow positions 135, 136, 137.

The controller 155 is in electrical communication with the various components of the electrical circuit 110. In particular, the controller 155 is in electrical communication with the steering input sensors 145, the illustrated first and second cylinder position sensors 151, 152, the spool position sensor 153, and the solenoid 143 of the steering control valve 142 via communication lines 160, 162, 164, 166, 168, respectively. The controller 155 is adapted to regulate the operation of the electro-hydraulic valve assembly 108 in response to electrical signals received from the steering input sensors 145 and the position sensors 151, 152, 153 via the communication lines 160, 162, 164, 166. The controller 155 comprises a processor and a non-transitory, tangible computer-readable storage medium bearing instructions that comprise a steering control application and a steering system monitoring application.

The steering control application of the controller 155 is adapted to receive the electrical input signals produced by the steering input sensors 145, process the steering information carried by the input signals, and transmit control signals to the electro-hydraulic valve assembly 108 based upon the steering input signals received from the steering input sensors 145. For example, in response to a steering wheel velocity input monitored via one of the steering input sensors 145, the controller 155 can reference a map stored in the memory thereof to determine a corresponding velocity command for the electro-hydraulic valve assembly 108 that results in an operator-desired steering velocity. In embodiments, the reference map can comprise a collection of data in the form of tables, graphs, and/or equations.

To perform electronic steering adjustment, the steering control application of the controller 155 can be adapted to monitor the position of the operator interface devices 27, 28 via the associated steering input sensors 145 and to transmit control signals to the electro-hydraulic valve assembly 108 to place the front frame 12 in the articulation angle θ, as calculated from the position of each of the right and left articulation cylinders 72, 73, corresponding with the position of the appropriate operator interface device 27, 28.

The steering system monitoring application of the controller 155 can be adapted to monitor the electro-hydraulic steering system 90 for failure events. The steering system monitoring application can be adapted to use the spool position system 150 to conduct failure event monitoring. When executed by the processor, the steering system monitoring application can perform several steps. A desired flow of pressurized fluid to the right articulation cylinder 72 and the left articulation cylinder 73 is determined based upon a particular steering signal received by the controller 155 from the steering input sensors 145. A desired spool position for the spool 134 of the electro-hydraulic valve assembly 108 is determined based upon the desired flow of pressurized fluid. An actual spool position is determined based upon the spool position signal received from the spool position system 150. The desired spool position and the actual spool position are compared to determine a spool-based flow error. The spool-based flow error over a predetermined period of time is summed to calculate a cumulative spool-based flow error for the predetermined period of time. The controller issues an event warning when the cumulative spool-based flow error for the predetermined period of time is outside of a predetermined range. The cumulative spool-based flow error can be reset to zero in response to an external signal which can be based on a number of machine factors and operator input commands.

The event warning can take different forms in different embodiments. In one embodiment, the event warning comprises a graphical image adapted for display on the display device 29 housed in the operator cab 25 of the machine 10. In other embodiments, the event warning can include an audibly perceptible message informing the operator of the nature of the failure event and/or informing the operator that the machine has experienced a failure event. In some embodiments, the controller can initiate a shut down sequence depending upon the nature of the failure event detected.

The steering system monitoring application can be adapted to use the articulation cylinder position system 148 to conduct failure event monitoring in the event that a fault condition is detected in the spool position system 150. When executed by the processor, the steering system monitoring application can determine a desired position for the right articulation cylinder 72 and the left articulation cylinder 73 based upon the desired flow of pressurized fluid. The steering system monitoring application can determine whether the spool position system 150 is in a fault condition. If a fault condition in the spool position system 150 is detected, the steering system monitoring application can switch to the cylinder position system 148 for information. The desired position for each of the right and left articulation cylinders 72, 73 can be compared to the respective actual cylinder position detected by the articulation cylinder position system 148 to determine a cylinder-based flow error. The cylinder-based flow error over a predetermined period of time can be summed or integrated to calculate a cumulative cylinder-based flow error for the predetermined period of time. The steering system monitoring application can be adapted to reset the cumulative cylinder-based flow error to zero in response to an external signal which can be based on a number of machine factors and operator input commands. The steering system monitoring application can issue an event warning when the cumulative cylinder-based flow error for the predetermined period of time is outside of a predetermined range.

The controller 155 can be any suitable controller know to one skilled in the art and can embody a single microprocessor or multiple microprocessors that include a means for controlling an operation of the electro-hydraulic steering system 90. Numerous commercially-available microprocessors can be configured to perform the functions of the controller 155, and one skilled in the art will appreciate that the controller 155 can be in the form of a general machine microprocessor configured to control numerous machine functions. In embodiments, the controller 155 can include a memory, a secondary storage device, a processor, and any other components for running an application. Various other circuits may be associated with the controller 155, such as, e.g., power supply circuitry, signal conditioning circuitry, solenoid driver circuitry, and other types of circuitry.

The computer components, software modules, functions, data stores and data structures described herein may be connected directly or indirectly to each other in order to allow the flow of data needed for their operations. It is also noted that an application or module can include but is not limited to a unit of code that performs a software operation, and can be implemented, for example, as a subroutine unit of code, a software function unit of code, an object (as in an object-oriented paradigm) or an applet and can be implemented in a computer script language or another type of computer code. The software components and/or functionality may be located on a single processor or distributed across multiple processors depending upon the particular circumstances surrounding its use.

In various embodiments, the steering system monitoring application constructed in accordance with principles of the present disclosure can take the form of a computer program product on a tangible, computer-readable storage medium having computer-readable program code means embodied in the storage medium. Software implementations of the steering system monitoring application as described herein can be stored on any suitable tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories.

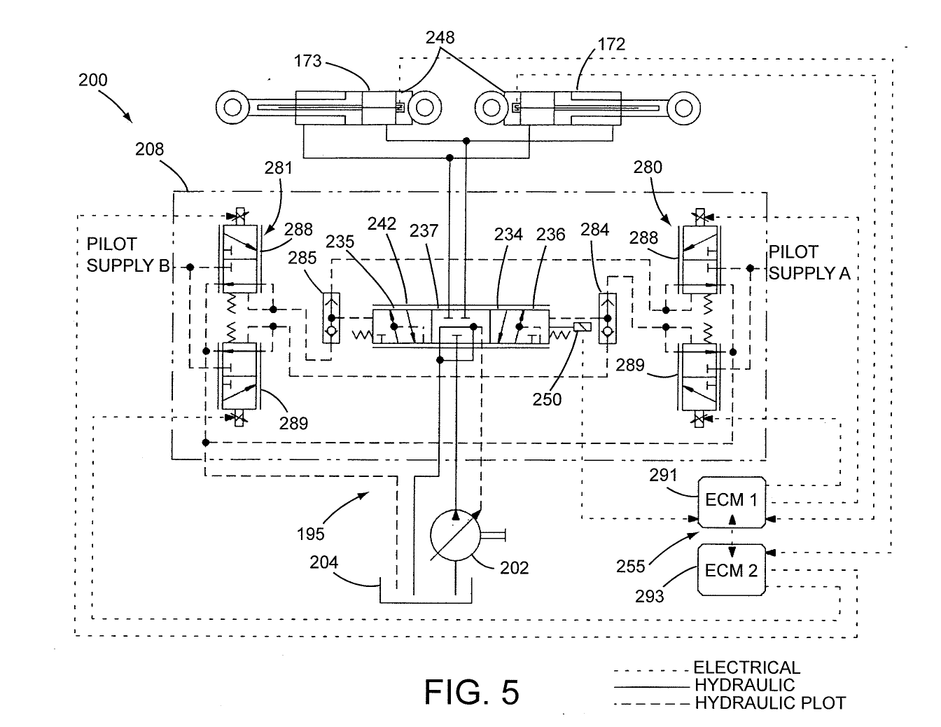

Referring to FIG. 5, an embodiment of a failure event warning system 200 of an electro-hydraulic steering system constructed in accordance with principles of the present disclosure is adapted to detect abnormal conditions of the electro-hydraulic steering system and provide an event warning to the operator when such a failure condition is detected. The failure event warning system 200 comprises a spool-position-based event warning system. The failure event warning system 200 can include a spool position system 250 integrated with a cylinder position system 248, both of which being in electrical communication with a controller 255. The cylinder position system 248 can act as a back-up system when there is a fault in the spool position system 250.

The failure event warning system 200 is shown in FIG. 5 operably arranged with a hydraulic circuit 195 of an electro-hydraulic steering system for a machine. The hydraulic circuit 195 includes a pump 202, a tank 204 in fluid communication with the pump 202, an electro-hydraulic valve assembly 208 in selective fluid communication with both the pump 202 and the tank 204, and first and second articulation cylinders 172, 173 each in selective fluid communication with the pump 202 and the tank 204 through the electro-hydraulic valve assembly 208.

The electro-hydraulic valve assembly 208 receives both controlled pilot hydraulic pressure and high hydraulic pressure from the pump 202 and produces controlled high hydraulic pressure for the first and second articulation cylinders 172, 173. The illustrated electro-hydraulic valve assembly 208 includes a steering control valve 242, housing a spool 234, first and second pilot valve assemblies 280, 281 to selectively move the spool 234, and a pair of resolvers 284, 285 arranged with the first and second pilot valve assemblies 280, 281. The spool 234 is movable over a range of travel between three flow positions 235, 236, 237 similar to the three flow positions 135, 136, 137 described in connection with the spool 134 of FIG. 4.

Each of the first and second pilot valve assemblies 280, 281 includes a pair of pilot valves 288, 289 configured to proportionally move the spool 234 from the third flow or neutral position 237 to the first flow position 235 and the second flow position 236, respectively. The resolvers 284, 285 are used to resolve between the first and second pilot valve assemblies 280, 281 for pilot control of the spool 234. The first pilot valve assembly 280 can act as a primary unit. In the event of a failure (or event), the second pilot valve assembly 281 can be employed.

The controller 255 comprises a first control module 291 in electrical communication with the spool position system 250 and with the cylinder position system 248 and a second control module 293 in electrical communication with the cylinder position system 248. The first control module 291 is in electrical communication with the first pilot valve assembly 280. The second control module 293 is in electrical communication with the second pilot valve assembly 281. The first and second control modules 291, 293 are in electrical communication with each other.

The controller 255 is adapted to perform failure event monitoring. When the failure event warning system 200 is operating in the spool-based manner, the controller 255 can operate the electro-hydraulic valve assembly 208 using the first pilot valve assembly 280. When the failure event warning system 200 is operating in the cylinder-based manner, the controller 255 can operate the electro-hydraulic valve assembly 208 using the second pilot valve assembly 281.

In embodiments, the controller 255 can be adapted to use the spool-based manner as the primary mode and to switch from the spool-based manner to the cylinder-based manner when a primary event is detected. In embodiments, the controller 255 can be adapted to switch to the cylinder-based manner if: (1) there is a problem with the spool position system 250 or (2) in the event of a primary system failure.

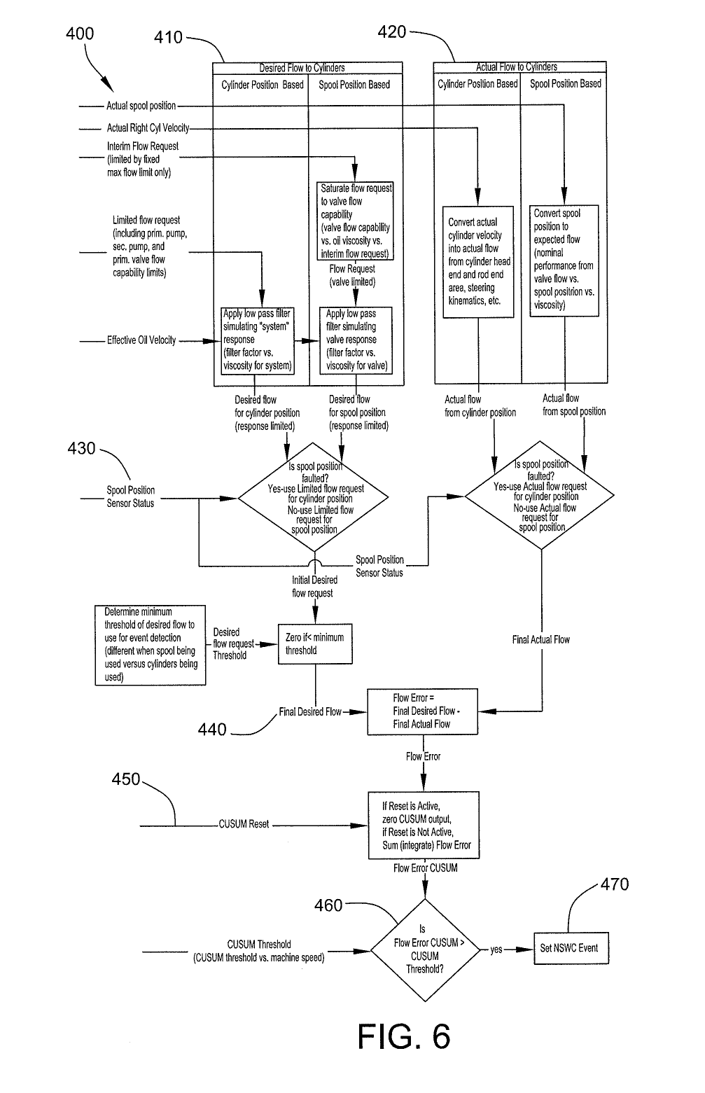

The components of the failure event warning system 200 can be similar in other respects to corresponding components shown in FIG. 4 and as described herein. The function of the failure event warning system 200 can be further understood in connection with the flowchart in FIG. 6.

Dedicated hardware implementations, including, but not limited to, application-specific integrated circuits, programmable logic arrays and other hardware devices, can likewise be constructed to implement the methods described herein. Furthermore, alternative software implementations, including, but not limited to, distributed processing or component/object distributed processing, parallel processing, or virtual machine processing, can also be constructed to implement the methods described herein.

### INDUSTRIAL APPLICABILITY

Embodiments of an electro-hydraulic steering system for a machine, a controller, and a method of monitoring an electro-hydraulic steering system of a machine are described herein. The industrial applicability of embodiments constructed according to principles of the present disclosure of an electro-hydraulic steering system for a machine, a controller, and a method of monitoring an electro-hydraulic steering system of a machine will be readily appreciated from the foregoing discussion. The described principles are applicable for use in multiple embodiments of a machine and have applicability in many machines which include a steering system using one or more hydraulic cylinders to rotate one portion of the machine with respect to another. Examples of such machines include motor graders, medium wheel loaders, haul trucks, off-highway mining trucks, etc.

In embodiments, an electro-hydraulic steering system constructed in accordance with principles of the present disclosure can be used with first and second articulation cylinders of an articulation joint of an articulated machine, such as in a wheel loader, for example. In other embodiments, an electro-hydraulic steering system constructed in accordance with principles of the present disclosure can be used with the right steering cylinder 78 and the left steering cylinder 79 adapted to be hydraulically operated to control the position of the front tires 18, such as in a motor grader for example. In still other embodiments, an electro-hydraulic steering system constructed in accordance with principles of the present disclosure can be used with another Ackerman-type steering linkage.

In embodiments, the present disclosure is directed to providing an electro-hydraulic steering system for a machine having a steering system failure warning system. In an embodiment, an electro-hydraulic steering system for a machine includes a controller comprising a processor and a non-transitory, tangible computer-readable storage medium bearing instructions comprising a steering system monitoring application adapted to monitor the steering system for a fault condition.

In embodiments, the steering system monitoring application is adapted to use the position of a spool of a steering control valve to determine the health of the steering system. This approach can be robust and maintain accurate operability in the presence of many noise factors that are uncontrollable, such as ambient conditions, underfoot conditions, and operator aggressiveness and/or abuse. In embodiments, an integration approach to the failure event detection strategy is taken wherein the error between the desired and the actual value is integrated over time and compared to a threshold value to determine health. In embodiments, the failure event detection strategy determines whether a specific value is achieved in a specific amount of time (i.e., a “hurdle”). In embodiments, the steering system monitoring application can be adapted to be applied to a position-input, velocity control system where the displacement of the input device away from a neutral position specifies a specific desired steering linkage velocity or articulation rate.

According to an embodiment of an event warning system of the present disclosure, the system utilizes a sensed spool valve position in conjunction with a cylinder position-based system to determine the condition of the electro-hydraulic steering system. The event warning system can be configured to detect an abnormal condition of the electro-hydraulic steering system of a machine and to provide a perceptible warning to the operator of the machine when such abnormal condition is detected. The provision of a spool-based position system integrated with a cylinder-based position system can help reduce the number of falsely-triggered warnings. The cylinder-based position system can act as a back up system when there is a fault condition present in the spool-based position system.

Referring to FIG. 6, steps of an embodiment of a method 400 of monitoring an electro-hydraulic steering system of a machine following principles of the present disclosure are shown in flowchart form. Desired flow of pressurized fluid to the first and second articulation cylinders 172, 173 is determined for both the cylinder position system 248 and the spool position system 250 (step 410) based upon the steering signal received by the controller 255. The desired flow of pressurized fluid for the cylinder position system 248 can be determined based on a limited flow request (e.g., based on the flow limits of the pumps, valves, etc.). The desired flow of pressurized fluid for the spool position system 250 can be determined based on an interim flow request (e.g., limited by a maximum flow limit of the spool 234).

The actual flow to the first and second articulation cylinders 172, 173 is determined for both the cylinder-based monitoring manner and the spool-based monitoring manner (step 420). The actual flow for the cylinder-based monitoring manner can be determined based on the actual cylinder velocity determined by the controller 255 through the signals received from the cylinder position system 248. The actual flow for the spool-based monitoring manner can be determined based on an actual position of the spool 234 determined using the spool position signal received from the spool position system 250.

Thereafter, the spool position system 250 can be checked for the presence of a fault condition (step 430). If no fault condition is detected, then fault event monitoring can occur by comparing the desired flow of pressurized fluid and the actual flow determined using the spool-based monitoring manner. If there is a fault condition detected, then fault event monitoring can occur by comparing the desired flow of pressurized fluid and the actual flow determined using the cylinder-based monitoring manner.

The final desired flow of pressurized fluid and the final actual flow are compared to determine a flow error (step 440). The flow error over a given time period, such as 5 milliseconds, e.g., is summed or integrated (Cusum) (step 450).

In embodiments, the steering signal received by the controller 255 can indicate that the operator is directing steering to occur. In this case, the monitoring operation can be configured to detect for a no-steering-with-command (NSWC) event. If such an event occurs, the operator has directed the steering system to steer a certain amount, but the system has not sufficiently responded. In other embodiments, the controller 255 receives a steering signal indicating that no steering should occur (e.g., the operator interface is in the neutral position). In such a case, the monitoring application can be configured to detect a steering-with-no-command (SWNC) event. If such an event occurs, the operator has directed that no steering should occur, but the system is steering beyond a designated threshold.

To detect for a no-steering-with-command (NSWC) event, the errors are compared and if the actual flow is less than the desired flow, this value is added into the Cusum value. In embodiments, to detect a steering-with-no-command (SWNC) event, i.e., when the desired flow is zero but the actual flow has value, the errors are compared and if the actual flow is greater than the desired flow, this value is added into the Cusum.

The Cusum value is compared to the designated threshold for either the spool-based monitoring manner or the cylinder-based monitoring manner (step 460). In embodiments, a reset condition can be provided via other machine conditions, and, in response, the Cusum value is reset to zero.

If the Cusum value is outside of a designated range, then an event is set and an event warning is issued to the operator (step 470). In embodiments, the event can be a NSWC (no steering with command) or a SWNC (steering-with-no-command) event, depending upon the steering signal received by the controller 255. In embodiments, the event warning is configured to be displayed by the display device 29 in the operator cab 25 of the motor grader 10. In embodiments, the threshold value for the Cusum value is different for the spool-based monitoring manner and the cylinder-based monitoring manner.

In one embodiment of a method of monitoring an electro-hydraulic steering system of a machine following principles of the present disclosure, a desired flow of pressurized fluid to a first cylinder is determined based upon a particular steering signal received by a controller. A desired spool position is determined, based upon the desired flow of pressurized fluid, for a spool of an electro-hydraulic valve assembly associated with the first cylinder. The electro-hydraulic valve assembly is adapted to selectively direct a source of pressurized fluid to the first cylinder. An actual spool position is determined using a spool position system. The desired spool position and the actual spool position are compared to determine a spool-based flow error. The spool-based flow error over a predetermined period of time is summed to calculate a cumulative spool-based flow error for the predetermined period of time. An event warning is issued when the cumulative spool-based flow error for the predetermined period of time is outside of a predetermined range. In embodiments, the cumulative spool-based flow error can be reset to zero in response to an external signal which can be based on a number of machine factors and operator input commands.

In embodiments, the first cylinder comprises a first articulation cylinder. The desired flow of pressurized fluid to the first articulation cylinder and a second articulation cylinder can be determined based upon the particular steering signal received by the controller. The desired spool position can be determined based upon the desired flow of pressurized fluid. The spool can be associated with the first articulation cylinder and the second articulation cylinder. The electro-hydraulic valve assembly can be adapted to selectively direct the source of pressurized fluid to the first articulation cylinder and the second articulation cylinder.

In embodiments, a desired position for the first articulation cylinder and the second articulation cylinder is also determined based upon the desired flow of pressurized fluid. The spool position system is checked to determine whether it is in a fault condition. If so, the method switches to a cylinder-based monitoring manner.

The desired position for the first articulation cylinder and the second articulation cylinder is compared to the respective actual cylinder position detected using an articulation cylinder position system to determine a cylinder-based flow error. The cylinder-based flow error over a predetermined period of time is summed or integrated to calculate a cumulative cylinder-based flow error for the predetermined period of time. An event warning is issued when the cumulative cylinder-based flow error for the predetermined period of time is outside of a predetermined range. In embodiments, the cumulative cylinder-based flow error can be reset to zero in response to an external signal which can be based on a number of machine factors and operator input commands.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. An electro-hydraulic steering system for a machine, the electro-hydraulic steering system comprising:
a controller;
an electro-hydraulic valve assembly in electrical communication with the controller, the electro-hydraulic valve assembly including a spool reciprocally movable over a range of travel between at least two flow positions, the electro-hydraulic valve assembly adapted such that the spool moves in response to a control signal received from the controller;
a spool position system having a sensor adapted to detect a position of the spool of the electro-hydraulic valve assembly and to generate a spool position signal indicative of the position of the spool, the spool position system in electrical communication with the controller and adapted to send the spool position signal to the controller;
a pump adapted to provide a source of pressurized fluid; and
a first cylinder in selective fluid communication with the pump;
wherein the electro-hydraulic valve assembly is adapted to selectively direct the source of pressurized fluid to the first cylinder in response to the control signal received from the controller;
wherein the controller is adapted to:
determine a desired flow of pressurized fluid to the first cylinder based upon a particular steering signal received by the controller,
determine a desired spool position for the spool of the electro-hydraulic valve assembly based upon the desired flow of pressurized fluid,
determine an actual spool position based upon the spool position signal received from the spool position system,
compare the desired spool position and the actual spool position to determine a spool-based flow error,
sum the spool-based flow error over a predetermined period of time to calculate a cumulative spool-based flow error for the predetermined period of time, and
issue an event warning when the cumulative spool-based flow error for the predetermined period of time is outside of a predetermined range.

2. The electro-hydraulic steering system of claim 1, wherein the controller is further adapted to:
reset the cumulative spool-based flow error to zero in response to an external signal.

3. The electro-hydraulic steering system of claim 1, wherein the first cylinder comprises a first articulation cylinder and further comprising:
a second articulation cylinder in selective fluid communication with the pump;
wherein the electro-hydraulic valve assembly is adapted to selectively direct the source of pressurized fluid to the first articulation cylinder and the second articulation cylinder in response to the control signal received from the controller; and
wherein the controller is adapted to determine the desired flow of pressurized fluid to the first articulation cylinder and the second articulation cylinder based upon the particular steering signal received by the controller.

4. The electro-hydraulic steering system of claim 3, further comprising:
an articulation cylinder position system adapted to detect a position of the first articulation cylinder and the second articulation cylinder and to generate a first cylinder position signal and a second cylinder position signal indicative of the position of the first articulation cylinder and the second articulation cylinder, respectively, the articulation cylinder position system in electrical communication with the controller and adapted to send the first cylinder position signal and the second cylinder position signal to the controller;
wherein the controller is adapted to:
determine a desired position for the first articulation cylinder and the second articulation cylinder based upon the desired flow of pressurized fluid,
determine whether the spool position system is in a fault condition, and, if so,
compare the desired position for each cylinder and the respective actual cylinder position detected by the articulation cylinder position system to determine a cylinder-based flow error,
sum the cylinder-based flow error over the predetermined period of time to calculate a cumulative cylinder-based flow error for the predetermined period of time, and
issue an event warning when the cumulative cylinder-based flow error for the predetermined period of time is outside of a predetermined range.

5. The electro-hydraulic steering system of claim 4, wherein the controller comprises a first control module in electrical communication with the spool position system and a second control module in electrical communication with the articulation cylinder position system.

6. The electro-hydraulic steering system of claim 3, wherein the first articulation cylinder and the second articulation cylinder each includes a body and a piston assembly disposed within the body and being reciprocally movable over a range of travel between a retracted position and an extended position, the piston assembly including a piston and a rod extending from the body, the body defining a piston-side chamber and a rod-side chamber, and wherein the electro-hydraulic valve assembly is adapted to selectively meter pressurized fluid to one of the piston-side chamber and the rod-side chamber of the first articulation cylinder and to simultaneously meter pressurized fluid to the other of the piston-side chamber and the rod-side chamber of the second articulation cylinder.

7. The electro-hydraulic steering system of claim 6, wherein the spool of the electro-hydraulic valve assembly is movable over a range of travel between a first flow position, a second flow position, and a third flow position, wherein:
in the first flow position, the source of pressurized fluid is allowed to flow from the source of pressurized fluid into the piston-side chamber of the first articulation cylinder and the rod-side chamber of the second articulation cylinder while allowing the fluid to drain from the rod-side chamber of the first articulation cylinder and the piston-side chamber of the second articulation cylinder,
in the second flow position, the source of pressurized fluid is allowed to flow in reverse directions relative to the first flow position, and
in the third flow position, the source of pressurized fluid is substantially prevented from flowing from the source of pressurized fluid to either the first articulation cylinder or the second articulation cylinder.

8. The electro-hydraulic steering system of claim 7, wherein the spool is biased to the third flow position.

9. The electro-hydraulic steering system of claim 7, wherein the electro-hydraulic valve assembly includes a steering control valve and a pilot valve, the steering control valve including the spool, and the pilot valve arranged with the steering control valve to selectively move the spool.

10. A controller for an electro-hydraulic steering system of a machine, the controller comprising a processor and a non-transitory, tangible computer-readable storage medium bearing instructions comprising a steering system monitoring application that, when executed by the processor, is adapted to:
determine a desired flow of pressurized fluid to a first cylinder for a particular steering condition,
determine a desired spool position for a spool of an electro-hydraulic valve assembly valve associated with the first cylinder based upon the desired flow of pressurized fluid,
determine an actual spool position based upon a spool position signal received from a spool position system,
compare the desired spool position and the actual spool position to determine a spool-based flow error,
sum the spool-based flow error over a predetermined period of time to calculate a cumulative spool-based flow error for the predetermined period of time, and
issue an event warning when the cumulative spool-based flow error for the predetermined period of time is outside of a predetermined range.

11. The controller of claim 10, wherein the steering system monitoring application is adapted to reset the cumulative spool-based flow error to zero in response to an external signal.

12. The controller of claim 10, wherein the first cylinder comprises a first articulation cylinder and wherein the steering system monitoring application is adapted to:
determine a desired flow of pressurized fluid to the first articulation cylinder and a second articulation cylinder for the particular steering condition, and
determine the desired spool position for the spool of the electro-hydraulic valve assembly valve associated with the first articulation cylinder and the second articulation cylinder based upon the desired flow of pressurized fluid.

13. The controller of claim 12, wherein the steering system monitoring application is adapted to:
determine a desired position for the first articulation cylinder and the second articulation cylinder based upon the desired flow of pressurized fluid,
determine an actual position for the first articulation cylinder and the second articulation cylinder based respectively upon a first cylinder position signal and a second cylinder position signal received from an articulation cylinder position system,
determine whether the spool position system is in a fault condition, and, if so,
compare the desired position for the first articulation cylinder and the second articulation cylinder and the respective actual cylinder position to determine a cylinder-based flow error,
sum the cylinder-based flow error over the predetermined period of time to calculate a cumulative cylinder-based flow error for the predetermined period of time, and
issue an event warning when the cumulative cylinder-based flow error for the predetermined period of time is outside of a predetermined range.

14. The controller of claim 13, wherein the steering system monitoring application is adapted to reset the cumulative cylinder-based flow error to zero in response to an external signal.

15. The controller of claim 13, wherein the steering system monitoring application is adapted to reset the cumulative spool-based flow error to zero in response to an external signal.

16. A method of monitoring an electro-hydraulic steering system of a machine, the method of monitoring comprising:
determining a desired flow of pressurized fluid to a first cylinder based upon a particular steering signal received by a controller;
determining a desired spool position, based upon the desired flow of pressurized fluid, for a spool of an electro-hydraulic valve assembly associated with the first cylinder, the electro-hydraulic valve assembly adapted to selectively direct a source of pressurized fluid to the first cylinder;
determining an actual spool position using a spool position system,
comparing the desired spool position and the actual spool position to determine a spool-based flow error;
summing the spool-based flow error over a predetermined period of time to calculate a cumulative spool-based flow error for the predetermined period of time; and
issuing an event warning when the cumulative spool-based flow error for the predetermined period of time is outside of a predetermined range.

17. The method of monitoring according to claim 16, further comprising:
re-setting the cumulative spool-based flow error to zero in response to an external signal.

18. The method of monitoring according to claim 16, wherein the first cylinder comprises a first articulation cylinder, the desired flow of pressurized fluid to the first articulation cylinder and a second articulation cylinder is determined based upon the particular steering signal received by the controller, and the desired spool position is determined based upon the desired flow of pressurized fluid, the spool being associated with the first articulation cylinder and the second articulation cylinder, and the electro-hydraulic valve assembly adapted to selectively direct the source of pressurized fluid to the first articulation cylinder and the second articulation cylinder.

19. The method of monitoring according to claim 18, further comprising:
determining a desired position for the first articulation cylinder and the second articulation cylinder based upon the desired flow of pressurized fluid;
determining whether the spool position system is in a fault condition, and if so,
comparing the desired position for the first articulation cylinder and the second articulation cylinder and the respective actual cylinder position detected using an articulation cylinder position system to determine a cylinder-based flow error,
summing the cylinder-based flow error over a predetermined period of time to calculate a cumulative cylinder-based flow error for the predetermined period of time, and
issuing an event warning when the cumulative cylinder-based flow error for the predetermined period of time is outside of a predetermined range.

20. The method of monitoring according to claim 19, further comprising:
resetting the cumulative cylinder-based flow error to zero in response to an external signal.
